(19) United States
(12) Patent Application Publication
(10) Pub. No.: US 2008/0313102 A1
(43) Pub. Date: Dec. 18, 2008

(54) Method of and system for estimating the cost and effort associated with preparing for and conducting a CMMI appraisal

(76) Inventor: Michael J. Campo, Stow, MA (US)

Correspondence Address: Iandiorio & Teska, 260 Bear Hill Road, Waltham, MA, 02451-1018, US

(21) Appl. No.: 11/818,645

(22) Filed: Jun. 15, 2007

(51) Int. Cl. G06Q 40/00

(52) U.S. Cl. 705/400; 707/1

(57) ABSTRACT

A method of and system for estimating the cost of and effort associated with preparing for and conducting a CMMI appraisal. A set of variables affecting a CMMI appraisal are input. Prior CMMI appraisal data is determined. The costs and effort associated with preparing for and conducting different stages of a CMMI appraisal are automatically calculated based on the inputs and the prior CMMI appraisal data. The costs and effort calculated are totaled and may be used to generate a report.

### FIELD OF THE INVENTION

This subject invention relates to a method of and system for estimating the cost of and effort required to prepare for and conduct a CMMI appraisal.

### BACKGROUND OF THE INVENTION

CMMI (Capability Maturity Model Integration) is a well-known collection of best practices against which organizations are appraised. In the CMMI model there are 22 process areas grouped under disciplines such as project management, process management, engineering, and support.

Companies and organizations are appraised in an evaluation or audit resulting in a CMMI maturity level ranging from 1-5. A maturity level of 2, for example, means the company has satisfactorily implemented 7 CMMI process areas while a maturity level of 5 means the company has satisfactorily implemented all 22 process areas.

Companies can seek an appraisal on different bases, for example, a company wide appraisal, an appraisal for one or more specific organizations within the company, or for specific projects carried out by the company. Typically, a company would choose an appraisal for different disciplines (e.g., systems engineering, software development, hardware engineering, and the like) and for different process areas seeking, for example, a maturity level of 4 (which includes 20 process areas) for software development and systems engineering taking into account a statistically relevant number of company projects.

A maturity level rating is valid for three years. Sometimes, a potential customer will require that a company be appraised and receive a given maturity level rating before choosing the company as a supplier or provider. And, a potential customer might require an appraisal more often than every three years. Over 1,500 CMMI appraisals have been reported by a wide variety of companies.

Preparing for and conducting a CMMI appraisal can be very expensive, for example $1-3M for a large company. Indeed, consultants are often hired and numerous CMMI consulting companies exist. One, Integrated System Diagnostics, Inc., markets a CMMI appraisal data management tool called “Appraisal Wizard” which assists companies in conducting CMMI appraisals. Management of a company about to undergo a CMMI appraisal often desires a cost and effort estimate for the appraisal in order to budget for the appraisal and to evaluate, before the appraisal, whether the cost will provide sufficient benefit.

Currently, the estimation of the cost of and effort associated with preparing for and conducting a CMMI appraisal is performed manually. Typically, no two CMMI appraisals include the same parameters (e.g., maturity level and disciplines). Therefore, the manual CMMI appraisal cost estimate process is detailed and time consuming and can also result in erroneous cost estimates.

### SUMMARY OF THE INVENTION

It is therefore an object of this invention to provide a model which estimates the cost of preparing for and conducting a CMMI appraisal.

It is a further object of this invention to reduce the time and the number of man-hours required to estimate the cost of preparing for and conducting a CMMI appraisal.

It is a further object of this invention to increase the accuracy of estimating the cost of preparing for and conducting a CMMI appraisal.

It is a further object of this invention to automate the estimation of the cost of preparing for and conducting a CMMI appraisal.

It is a further object of this invention to estimate the effort level required for a given CMMI appraisal.

The subject invention results from the realization that by treating the estimation of the cost of preparing for and conducting a CMMI appraisal as a project and by taking into account data from prior CMMI appraisals, a model can be developed for automatically, quickly, and more accurately calculating the expected cost associated with and the effort involved in preparing for and conducting each stage of a CMMI appraisal.

The subject invention, however, in other embodiments, need not achieve all these objectives and the claims hereof should not be limited to structures or methods capable of achieving these objectives.

The subject invention features a method of estimating the cost of and effort associated with preparing for and conducting a CMMI appraisal. The method preferably includes inputting a set of variables affecting a CMMI appraisal, determining prior CMMI appraisal data, and automatically calculating, based on the inputs and the prior CMMI appraisal data, the cost and effort associated with preparing for and conducting different stages of a CMMI appraisal. The cost and effort figures calculated are totaled and then output.

A typical cost is evidence collection and the set of variables include the number of projects to be included in the CMMI appraisal, the number of process areas to be included in the CMMI appraisal, the number of disciplines to be included in the CMMI appraisal, and a labor rate. The prior CMMI appraisal data then includes the time required to collect evidence per process area. Another typical cost is evidence review. The set of variables then includes the number of process areas to be included in the CMMI appraisal, the number of disciplines to be included in the CMMI appraisal, the number of projects to be included in the CMMI appraisal, and a labor rate. The prior CMMI appraisal data includes the time required to review evidence per process area.

Further included may be the step of storing the prior CMMI appraisal data in a database. Automatically calculating may include entering equations in the cells of a spreadsheet and inputting may include entering the variables in cells of the spreadsheet. Further included may be the step of updating the database data based on actual CMMI appraisal data for an appraisal conducted after its costs and efforts have been estimated. Different variables representing a plurality of options for a given CMMI appraisal can be input and the total cost and effort for each option is output. Different options may include different disciplines and/or different process areas. Different stages may include a process baseline appraisal stage, an appraisal readiness review stage, and the Standard CMMI Appraisal for Process Improvement stage.

In one example, the method of estimating the cost of preparing for and conducting a CMMI appraisal includes inputting a set of variables including the number of projects to be included in the appraisal, the number of process areas to be included in the appraisal, the number of disciplines to be included in the appraisal, and a labor rate; determining prior CMMI appraisal data including the time required to collect evidence per process area and the time required to review evidence per process area; and automatically calculating, based on the input and the prior CMMI appraisal data, the cost of evidence collection and the cost of evidence review.

The subject invention also features a system for estimating the cost of and effort associated with preparing for and conducting a CMMI appraisal. The typical system includes a user interface for inputting a set of variables affecting a CMMI appraisal, a database populated with prior CMMI appraisal data, and an engine configured to automatically calculate, from the inputs and the database, the total cost and effort required to prepare for and conduct the CMMI appraisal. There are also means for outputting the total cost and effort.

The user interface may include cells in a spreadsheet. The engine may include equations in the cells of a spreadsheet. The means for outputting may be configured to generate a report representing a plurality of options for a given CMMI appraisal and the total cost and effort for each option.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram of an example of a system for and method of estimating the cost of and effort associated with preparing for and conducting a CMMI appraisal in accordance with this invention;

FIG. 2 is an example of a report generated using the system shown in FIG. 1;

FIG. 3 is an example of a worksheet useful in connection with the subject invention;

FIGS. 4A-4B show examples of the data stored in the database shown in FIG. 1;

FIGS. 5A-5E show examples of screen displays useful for calculating cost data in accordance with the subject invention; and

FIGS. 6A-6C are examples of screen displays useful for calculating the effort required for a particular CMMI appraisal.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

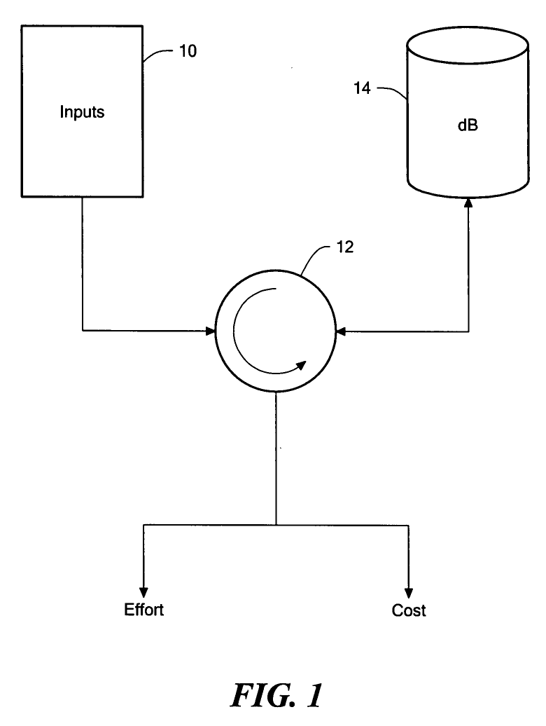

FIG. 1 shows an example of a system for and method of estimating the cost and effort (e.g., staff months) associated with preparing for and conducting a CMMI appraisal in accordance with the subject invention.

User interface 10 is for inputting a set of variables affecting a CMMI appraisal. The user interface may be as simple as a worksheet wherein data on the worksheet is entered into cells of a spreadsheet operating on software engine 12. Or, the user interface may include a specially programmed software module which prompts the user to enter the required data.

Typical variables input to engine 12 include the number of company projects participating in the CMMI appraisal, the number of engineering disciplines participating (such as software engineering, systems engineering, hardware engineering), and/or organizational representation, and the scope of the CMMI model (number of process areas). Additional inputs include the estimated labor rate(s), the size of the appraisal team, the make up of the appraisal team (for example, the number of company appraisers and the number of external consultants on the appraisal team), the consultancy fees, the time duration of the appraisal, the site support required, and the number of interviewees.

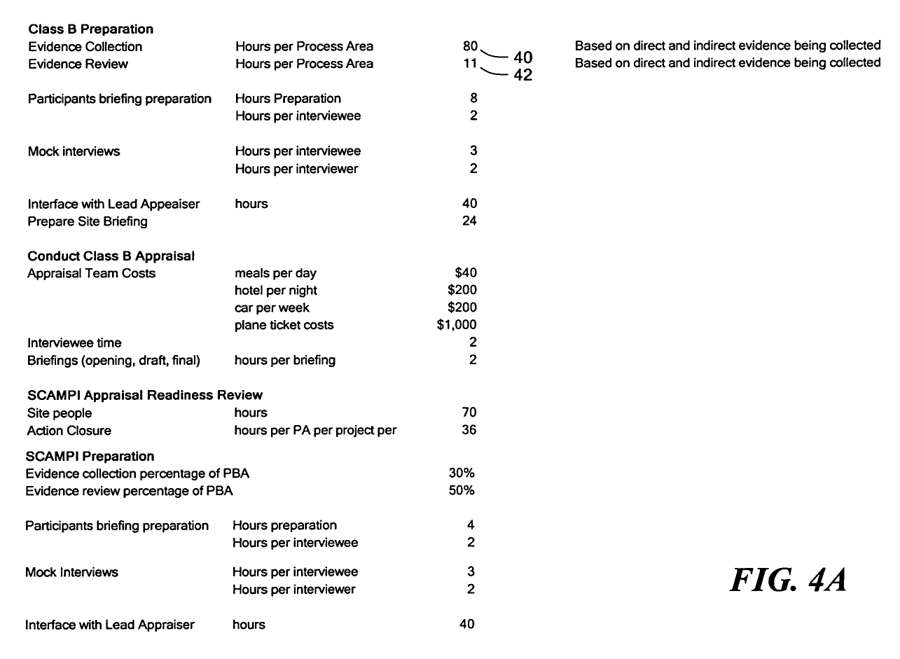

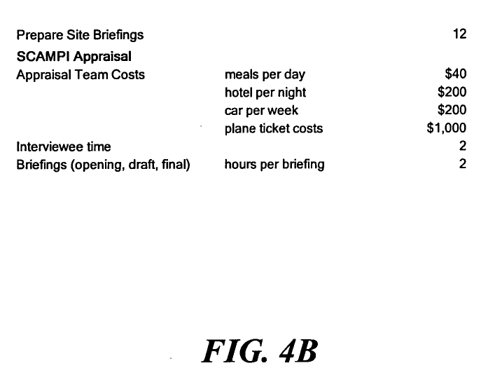

Database 14 is populated with prior CMMI appraisal data such as the time required to collect evidence per CMMI process area, the time to review evidence per process areas, and the like. See FIGS. 4A-4B discussed below.

Software engine 12 is configured to automatically calculate, based on the inputs 10 and the data in database 14, the cost and effort associated with preparing for and conducting different stages of a CMMI appraisal (e.g., process baseline appraisal, an appraisal readiness review, and SCAMPI or the Standard CMMI Appraisal for Process Improvement).

In one example, software engine 12 includes cells of a spreadsheet programmed with equations which solve different cost and/or effort figures based on the inputs and the data in database 14. Thus, one cell of the spread sheet is programmed to calculate the cost of evidence collection as:

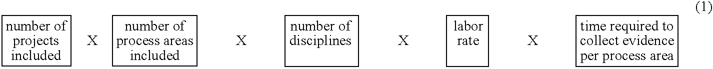

Another cell is programmed to calculate the cost of evidence review as:

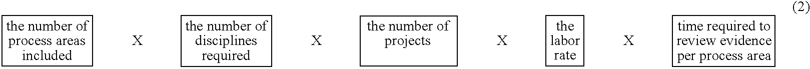

The number of projects included, the number of process areas included, the number of disciplines, and the labor rate are inputs. The time required to collect evidence per process area and the time required to review evidence per process area is data obtained from database 14.

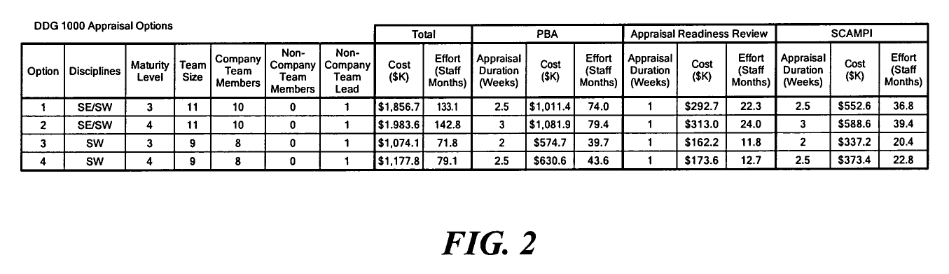

Software engine 12 is then configured to output the effort required for and the costs associated with a CMMI appraisal based on the calculations. The output means can be configured to provide outputs for various options which can be summarized in a report as shown in FIG. 2. Here, four options are provided to management delineating the total cost and effort for each option and the cost and effort associated with each stage of the appraisal is also provided.

For option number 1, for example, two disciplines are selected (system engineering and software engineering), the maturity level is set at 3 (based on the number of CMMI process areas to be included in the appraisal), the size of the appraisal team is set at 11, there are 10 company team members, and no consultants as team members except a consultant lead team member. The duration of each stage, the cost of each stage, and the effort required is provided as is the total as shown.

In this way, an accurate estimate of the cost and effort associated with preparing for and conducting a CMMI appraisal is provided quickly and automatically. The output of engine 12 can be tailored to meet the needs of management and those within the company who budget and plan for a CMMI appraisal. Different options or scenarios can be run to maximize the benefit received from a given appraisal based on the estimated cost and effort.

After an appraisal, database 14, FIG. 1 can be updated to reflect the actual data obtained from a real appraisal. Also, where there are disparities between the estimated and actual costs and effort, the equations of the spreadsheet cells can be refined or tailored.

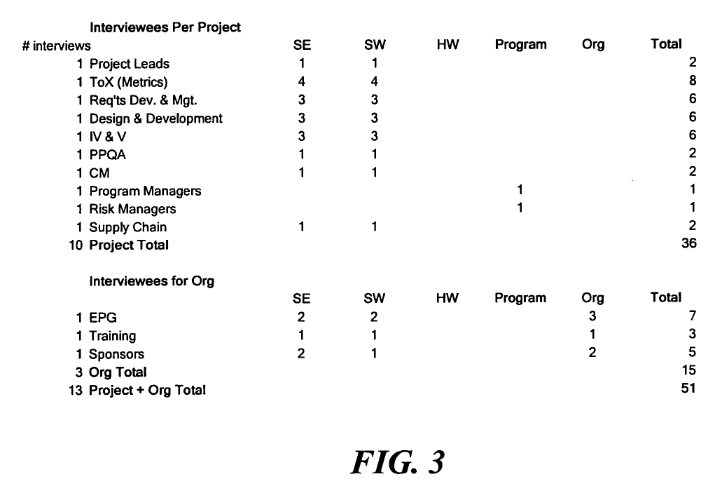

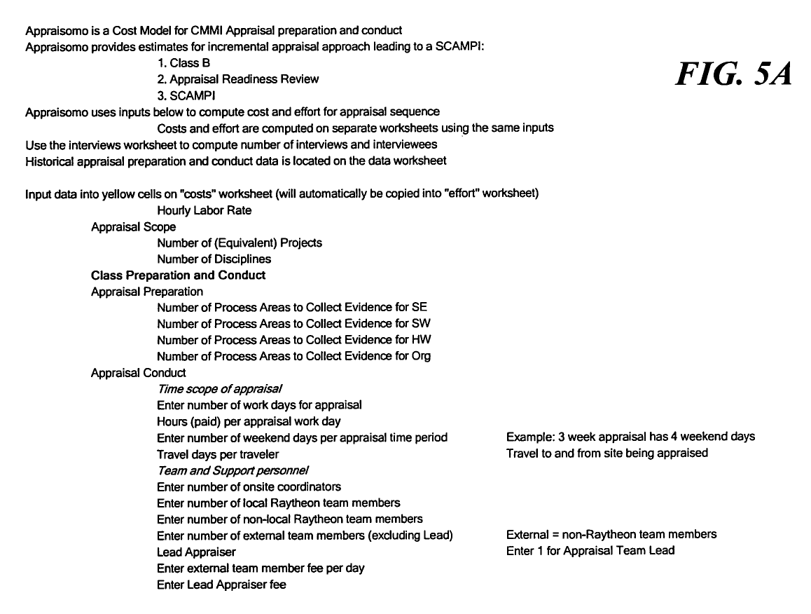

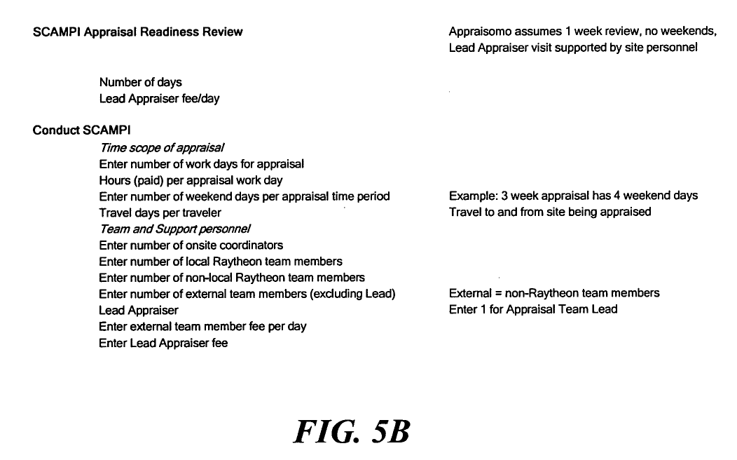

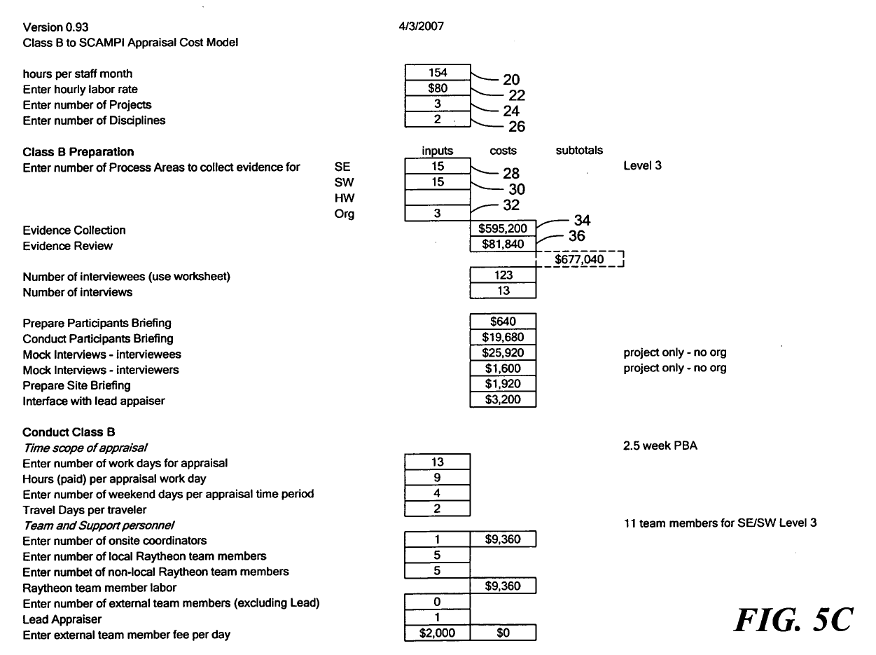

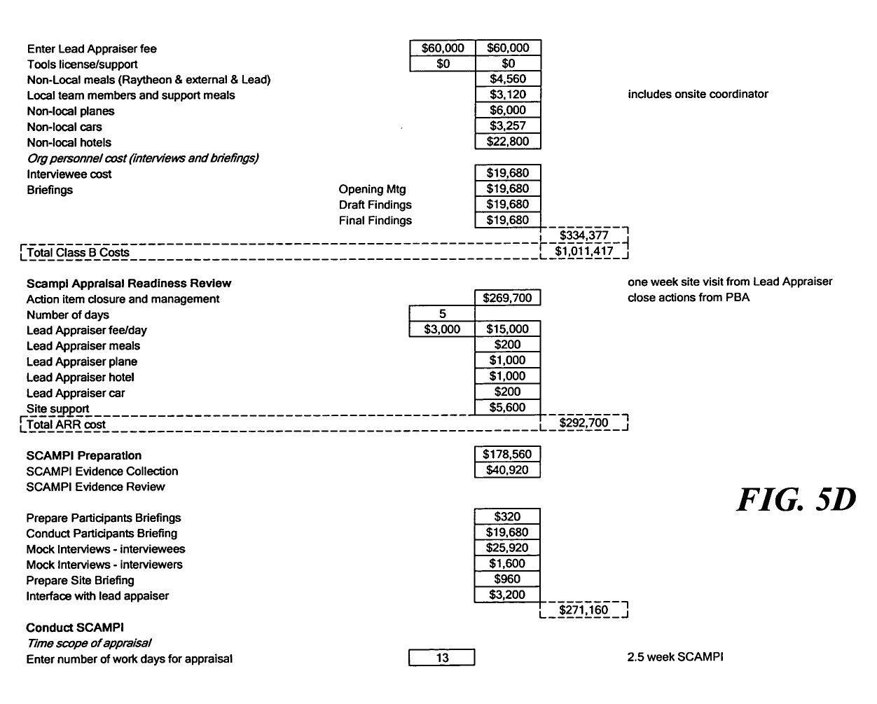

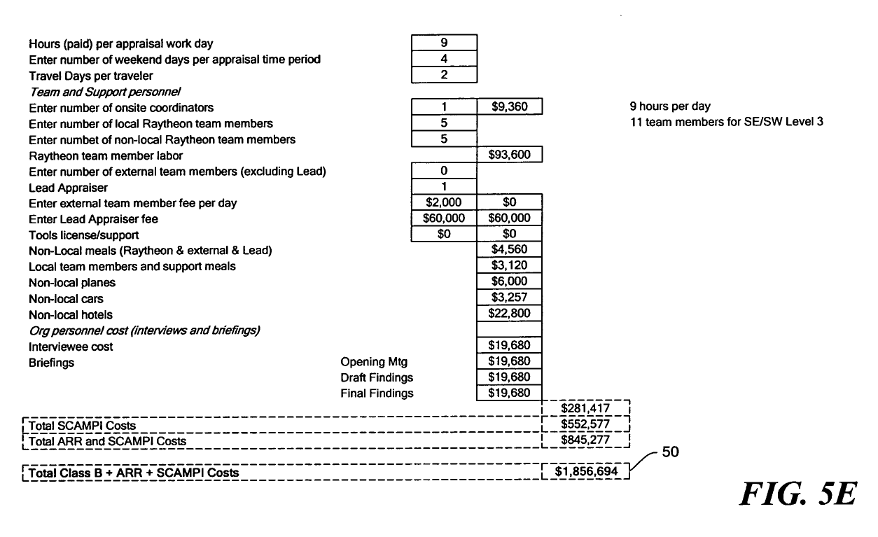

FIG. 3 shows an example of a worksheet useful for entering the inputs 10, FIG. 1. FIGS. 4A-4B shows an example of historical appraisal preparation and conduct data in a simplified version of database 14, FIG. 1. FIGS. 5A-5E are screen displays showing the user interface and the cells associated with software engine 12, FIG. 1. As shown in FIG. 5C, the user has entered the hours per staff month in cell 20, the hourly labor rate in cell 22, the number of projects to be included in the CMMI appraisal in cell 24, and the number of disciplines to be included in cell 26. In cell 28, 15 CMMI process areas have been chosen for systems engineering. In Cell 30, 15 CMMI process areas have been chosen for software engineering. In cell 32, 3 CMMI process areas have been entered for organizational activities. Some process areas are related to organizational activities (such as training) as oppose to systems, software, or hardware engineering disciplines. Cell 34 has been programmed in accordance with equation 1 above and it calculates the cost of evidence collection based on the inputs from cells 24, 26, 28, 30, 32, 22, and historical data 40, FIG. 4A. The values of cells 28 and 30 are added together and multiplied by the number in cell 24. The value of cell 32 is added. That subtotal is multiplied by the value of cell 22 and by the value of cell 40. Cell 36, FIG. 5C, in turn, is programmed in accordance with equation 2 above and it calculates the cost of evidence review based on cells 24, 28, 30, 32, 26, 22, and the historical data 42, FIG. 4A. The valued of cells 28 and 30 are added and multiplied by the value of cell 24. The value of cell 32 is added. That subtotal is then multiplied by the values of cells 22 and 42. All the costs calculated in the cells of FIGS. 5C-5E are then totaled as shown at 50 in FIG. 5E.

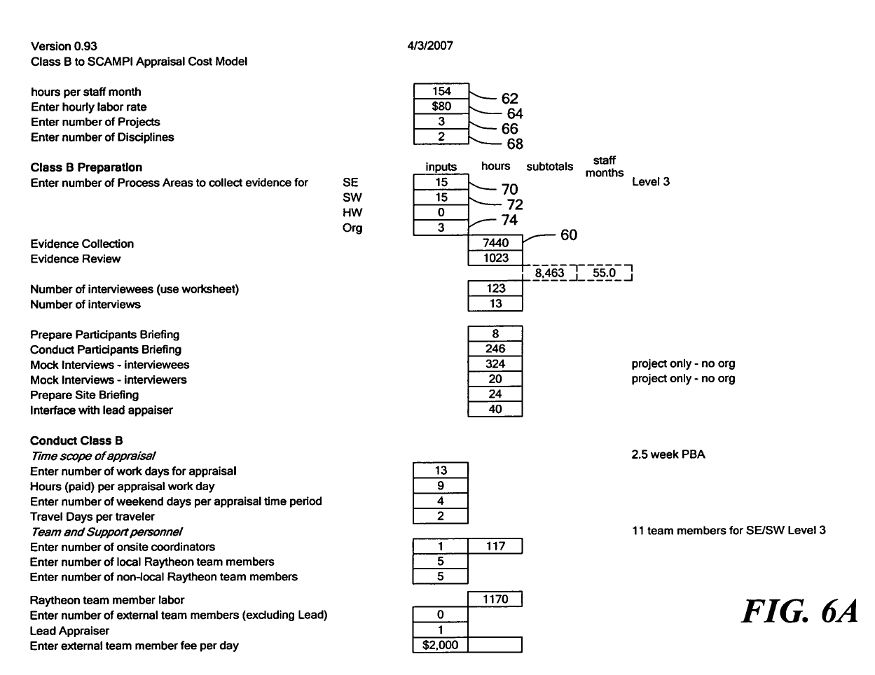

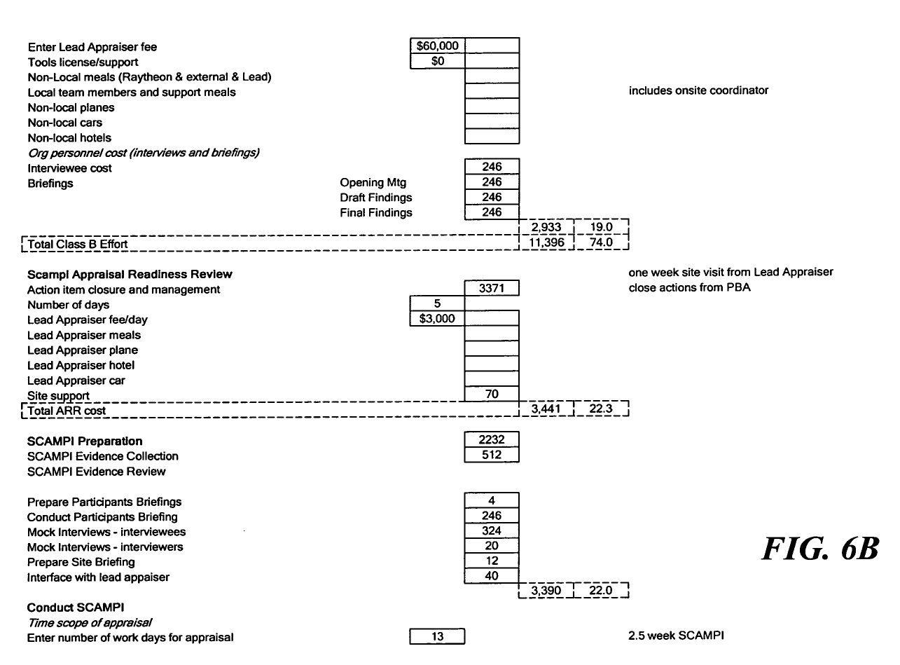

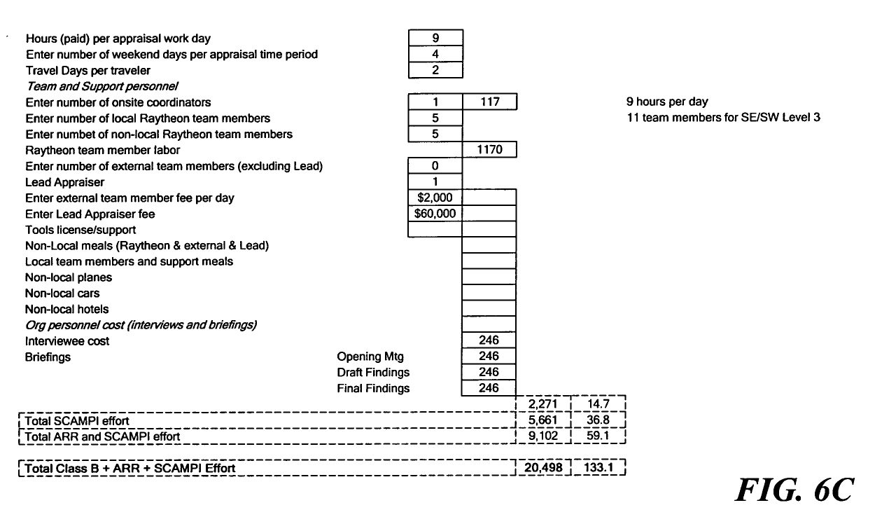

FIGS. 6A-6C show the inputs required to calculate the effort associated with a particular CMMI appraisal. Evidence collection in cell 60, for example, is based on cells 62-74 and historical data 40, FIG. 4A.

The inputs, equations, and report format may vary from user to user and software engine 12 need not be based on a spreadsheet as discussed herein. Standard programming techniques can be used to generate a user interface with a number of reporting formats or templates.

The result, in any embodiment, is a cost model when none existed before for automatically estimating the costs and effort associated with preparing for and conducting a CMMI appraisal.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A method of estimating the cost of and effort associated with preparing for and conducting a CMMI appraisal, the method comprising:
inputting a set of variables affecting a CMMI appraisal;
determining prior CMMI appraisal data;
automatically calculating, based on the inputs and the prior CMMI appraisal data, the costs and effort associated with preparing for and conducting different stages of a CMMI appraisal;
totaling the costs and effort calculated; and
outputting the total cost and effort.

2. The method of claim 1 in which one cost is evidence collection and the set of variables include the number of projects to be included in the CMMI appraisal, the number of process areas to be included in the CMMI appraisal, the number of disciplines to be included in the CMMI appraisal, and a labor rate.

3. The method of claim 2 in which the prior CMMI appraisal data includes the time required to collect evidence per process area.

4. The method of claim 1 in which a cost is evidence review and the set of variables includes the number of process areas to be included in the CMMI appraisal, the number of disciplines to be included in the CMMI appraisal, the number of projects to be included in the CMMI appraisal, and a labor rate.

5. The method of claim 4 in which the prior CMMI appraisal data includes the time required to review evidence per process area.

6. The method of claim 1 further including the step of storing the prior CMMI appraisal data in a database.

7. The method of claim 1 in which automatically calculating includes entering equations in the cells of a spreadsheet.

8. The method of claim 7 in which inputting includes entering said variables in cells of the spreadsheet.

9. The method of claim 6 further including the step of updating said database data based on actual CMMI appraisal data for an appraisal conducted after its costs and efforts have been estimated.

10. The method of claim 1 in which different variables representing a plurality of options for a given CMMI appraisal are input and the total cost and effort for each option is output.

11. The method of claim 10 in which the options include different disciplines and/or different process areas.

12. The method of claim 1 in which the different stages include a process baseline appraisal stage, an appraisal readiness review stage, and the Standard CMMI Appraisal for Process Improvement stage.

13. A method of estimating the cost of preparing for and conducting a CMMI appraisal, the method comprising:
inputting a set of variables including the number of projects to be included in the appraisal, the number of process areas to be included in the appraisal, the number of disciplines to be included in the appraisal, and a labor rate;
determining prior CMMI appraisal data including the time required to collect evidence per process area and the time required to review evidence per process area; and
automatically calculating, based on the input and the prior CMMI appraisal data, the cost of evidence collection and the cost of evidence review.

14. A system for estimating the cost of and effort associated with preparing for and conducting a CMMI appraisal, the system comprising:
a user interface for inputting a set of variables affecting a CMMI appraisal;
a database populated with prior CMMI appraisal data;
an engine configured to automatically calculate, from the inputs and the database, the total cost and effort required to prepare for and conduct the CMMI appraisal; and
means for outputting the total cost and effort.

15. The system of claim 14 in which the user interface includes cells in a spreadsheet.

16. The system of claim 14 in which one cost is evidence collection and the set of variables include the number of projects to be included in the CMMI appraisal, the number of process areas to be included in the CMMI appraisal, the number of disciplines to be included in the CMMI appraisal, and a labor rate.

17. The system of claim 16 in which the database includes the time required to collect evidence per process area.

18. The system of claim 14 in which a cost is evidence review, the set of variables includes the number of process areas to be included in the CMMI appraisal, the number of disciplines to be included in the CMMI appraisal, the number of projects to be included in the CMMI appraisal, and a labor rate.

19. The system of claim 18 in which the database includes the time required to review evidence per process area.

20. The system of claim 14 in which the engine includes equations in the cells of a spreadsheet.

21. The system of claim 14 in which the means for outputting is configured to generate a report representing a plurality of options for a given CMMI appraisal and the total cost and effort for each option.

22. The system of claim 21 in which the options include different disciplines and/or different process areas.

23. The system of claim 21 in which the means for outputting generates a report including different CMMI stages including a process baseline appraisal stage, an appraisal readiness review stage, and the Standard CMMI Appraisal for Process Improvement stage.
